(19) United States
(12) Patent Application Publication
(10) Pub. No.: US 2012/0154439 A1
(43) Pub. Date: Jun. 21, 2012

(54) APPARATUS AND METHOD FOR OPERATING MULTIPLE OBJECT OF AUGMENTED REALITY SYSTEM

(75) Inventors: Jae Young Ahn, Daejeon (KR); Sungmo Jung, Daejeon (KR); Jae-gu Song, Daejeon (KR); Seoksoo Kim, Daejeon (KR)

(73) Assignee: Electronics and Telecommunications Research Institute, Daejeon (KR)

(21) Appl. No.: 13/287,636

(22) Filed: Nov. 2, 2011

(30) Foreign Application Priority Data
Dec. 16, 2010 (KR) 10-2010-0129400
Apr. 19, 2011 (KR) 10-2011-0041114

(51) Int. Cl. G09G 5/00

(52) U.S. Cl. 345/633

(57) ABSTRACT

An apparatus for operating multiple objects in an augmented reality system converts a reference point recognized in an input image into copyable basic data, then copies the basic data to each position of a screen where the image is to be output, and then augments an object by using a copy of the basic data as the reference point.

### CROSS-REFERENCE TO RELATED APPLICATION

This application claims priority to and the benefit of Korean Patent Application Nos. 10-2010-0129400 and 10-2011-0041114 filed in the Korean Intellectual Property Office on Dec. 16, 2010 and Apr. 29, 2011, the entire contents of which are incorporated herein by reference.

### BACKGROUND OF THE INVENTION

(a) Field of the Invention

The present invention relates to an apparatus and method for operating multiple object in an augmented reality system, and more particularly, to the generation of reference points of multiple objects in an augmented reality system.

(b) Description of the Related Art

With the development of computer technologies, users can experience virtual reality in many aspects of their lives. Mixed reality refers to the merging of virtual reality and real environments to produce new worlds. The mixed reality is divided into augmented reality and augmented virtuality depending on whether the primary environment is real or virtual.

The augmented reality based on real environments renders data not available in real environments as a virtual image through computer technology.

To realize such augmented reality, it is necessary to determine at which position of an image input from a camera an object is to be augmented. Augmentation methods for realizing the augmented reality may be classified into marker base recognition and markerless base recognition.

The marker base recognition is a method of augmenting an object by using a marker having a unique pattern as a reference point, and the markerless base recognition is a method of augmenting an object by using information of a real world object recognized by a computer as a reference point.

In the marker base recognition, one marker is actually placed, then the marker is recognized from an image acquired from a camera, and then one object is augmented. In order to augment multiple objects, another identical marker is additionally placed, then the marker is recognized from the image acquired from the camera, and then another object is augmented. In other words, in order to augment multiple objects, there is the inconvenience of placing markers one by one and recognizing the markers from the image acquired from the camera.

### SUMMARY OF THE INVENTION

The present invention has been made in an effort to provide an apparatus and method for operating multiple objects in an augmented reality system, which can reduce the inconvenience caused by the generation of reference points of multiple objects.

An exemplary embodiment of the present invention provides a method for operating multiple objects in an augmented reality system. The method for operating multiple objects includes: recognizing a reference point in an input image; converting the reference point into basic data by pre-processing the reference point by binarization; copying the basic data to at least one position of a screen where the image is to be output; and augmenting an object on the screen by using a copy of the basic data as the reference point.

The converting may include: extracting the contour of the reference point; and pre-processing the contour by binarization.

The extracting may include: extracting initial contours running parallel to and enclosing the contour of the reference point by using the Hough Transform Algorithm; and coloring the space between two of the initial contours.

The copying may include setting up a protection area corresponding to each basic data so as to prevent overlap of the basic data when the basic data is copied to at least one position of the screen. In the setting up, the Bresenham Algorithm may be used.

The copying may include removing image noise from the basic data before copying the basic data to the screen.

Moreover, the image noise may be removed by applying the Mean Shift Algorithm to the basic data.

In the copying, if a copy of the basic data is beyond the coverage of the screen, at least one of the number of reference points and the size of the reference points may be controlled.

Another exemplary embodiment of the present invention provides an apparatus for operating multiple objects in an augmented reality system. The multiple object operating apparatus includes a reference point recognition unit, a basic data generator, a copying unit, and an augmentation unit. The reference point recognition unit recognizes a reference point in an input image. The basic data generator converts the reference point into copyable basic data. The copying unit copies the basic data to at least one position of the screen where the image is to be output. The augmentation unit augments an object on the screen by using the basic data as the reference point.

The copying unit sets up a protection area corresponding to each basic data so as to prevent overlap of the basic data when the basic data is copied.

Also, the copying unit may copy the basic data to the screen after removing image noise from the basic data.

The basic data generator may convert the reference point into copyable basic data by extracting the contour of the reference point and binarizing the same.

According to the exemplary embodiments of the present invention, the performance of generation of reference points of multiple objects can be improved, as compared to the conventional method of generating reference points of multiple objects, because the multiple objects are operated by copying a reference point to multiple positions in an augmented reality image. Moreover, the present invention is expected to be applicable to all fields where an augmented reality image is applied.

### BRIEF DESCRIPTION OF THE DRAWINGS

FIG. 1 is a flowchart showing a method for operating multiple objects in an augmented reality system according to an exemplary embodiment of the present invention.

FIG. 2 is a flowchart showing a method of copying the basic data shown in FIG. 1 on the screen.

FIG. 3 is a view schematically showing an apparatus for operating multiple objects according to an exemplary embodiment of the present invention.

FIG. 4 is a schematic view of an apparatus for operating multiple objects according to another exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising”, will be understood to imply the inclusion of stated elements but not the exclusion of any other elements.

Now, an apparatus and method for operating multiple objects in an augmented reality system according to an exemplary embodiment of the present invention will be described in detail with reference to the drawings.

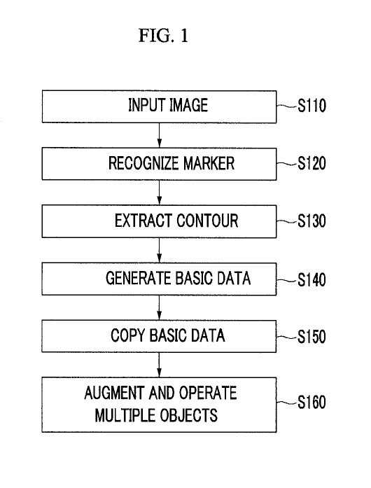

FIG. 1 is a flowchart showing a method for operating multiple objects in an augmented reality system according to an exemplary embodiment of the present invention.

Referring to FIG. 1, when an image is input from a camera (S110), the multiple object operating apparatus of the augmented reality system recognizes a marker serving as a reference point of an additional object for multi-object augmentation (S120). That is, one marker is placed on a real world object to be photographed, then an image is taken with a camera, and then the taken image is input into the multiple object operating apparatus. For example, if the user wants to photograph the top of a desk, a marker needs to be placed on the desk.

The multiple object operating apparatus extracts the contour of a recognized marker (S130). Specifically, the multiple object operating apparatus extracts initial contours for extracting the actual contour of the marker by applying the Hough Transform Algorithm to the recognized marker. An initial contour is a line consisting of points of one pixel, which runs parallel to the actual contour to be extracted from the marker. Next, the multiple object operating apparatus extracts the actual contour of the marker in such a manner that the line trajectory is restored by coloring the space between the initial contours running parallel to each other among the initial contours enclosing the actual contour to be extracted from the marker. At this point, the marker can be prevented from expanding in size by coloring only in the facing direction of the initial contours. At this point, the multiple object operating apparatus is able to remove the color for homogenizing multiple reference points.

Next, the multiple object operating apparatus generates basic data by binarizing the contour of the marker (S140).

The multiple object operating apparatus copies the basic data to a copy position on the screen where an image is to be output (S150). At this point, at least one copy position may be provided, and can be designated by the user.

In other words, the multiple object operating apparatus according to an exemplary embodiment of the present invention recognizes one marker in an image to generate basic data, and then copies the basic data later and uses it as the reference point of an additional object for multi-object augmentation. In this way, the reference points of multiple objects can be generated on an image quickly and efficiently, as compared to the conventional method in which the markers corresponding to the reference points of multiple objects are placed one by one on a real world object, an image is taken with a camera, and the reference points of the multiple objects are generated on the image.

Next, the multiple object operating apparatus operates the multiple objects by augmenting the multiple objects with a copy of the basic data (S160).

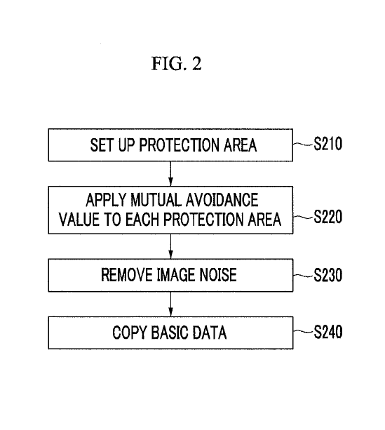

FIG. 2 is a flowchart showing a method of copying the basic data shown in FIG. 1 on the screen.

Referring to FIG. 2, the multiple object operating apparatus sets up a circular protection area at the position where the basic data is to be copied by using the Bresenham Algorithm (S210).

The multiple object operating apparatus applies a mutual avoidance value to each protection area so as to prevent overlap of the reference points, i.e., markers, when the basic data is copied to multiple positions (S220).

Next, the multiple object operating apparatus copies the basic data to the corresponding position (S240). At this point, the multiple object operating apparatus may adjust at least one of the number of reference points and the size of the reference points so that multiple objects can be output on one screen if a copy of the basic data is beyond the coverage of the screen.

Meanwhile, the multiple object operating apparatus can remove image noise by applying the Mean Shift Algorithm to the basic data before copying the basic data to the corresponding position (S230). By thusly removing image noise, the recognition rate of the reference points can be improved.

Moreover, the multiple object operating apparatus is able to copy the basic data to a certain position of the screen by applying a randomized function to distribute the multiple objects uniformly on the screen in the copying process of the basic data. For example, when copying 20 basic data units on the output screen of 400*300, the basic data is copied to a certain position of the output screen by applying a randomized function.

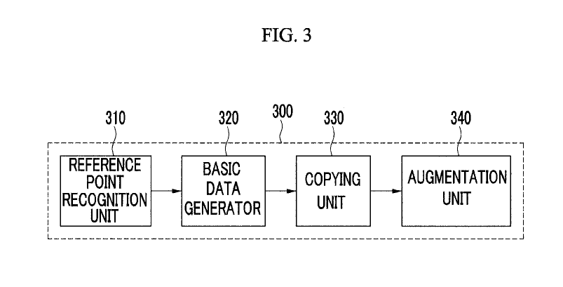

FIG. 3 is a view schematically showing an apparatus for operating multiple objects according to an exemplary embodiment of the present invention.

Referring to FIG. 3, the multiple object operating apparatus 300 includes a reference point recognition unit 310, a basic data generator 320, a copying unit 330, and an augmentation unit 340.

The reference point recognition unit 310 recognizes a marker serving as a reference point in an input image.

The basic data generator 320 converts the recognized marker into basic data copyable onto the screen. That is, the basic data generator 320 extracts the contour by applying the Hough Transform Algorithm to the recognized marker, and generates basic data by pre-processing the extracted contour by binarization. By doing so, the marker is converted into basic data copyable on the screen. Thus, the reference points of multiple objects can be generated by copying the basic data to multiple positions of the screen.

The copying unit 300 sets up a protection area of each basic data at the position where the basic data is to be copied by applying the Bresenham Algorithm so as to prevent overlap of the reference points, i.e., markers, when the basic data is copied to multiple positions. At this point, the copying unit 330 can remove image noise by applying the Mean Shift Algorithm to the basic data before copying the basic data.

The augmentation unit 340 operates the multiple objects by augmenting the multiple objects with a copy of the basic data.

At least some of the functions of the above-described apparatus and method for operating multiple objects according to the exemplary embodiment of the present invention can be implemented by hardware or by software in combination with hardware.

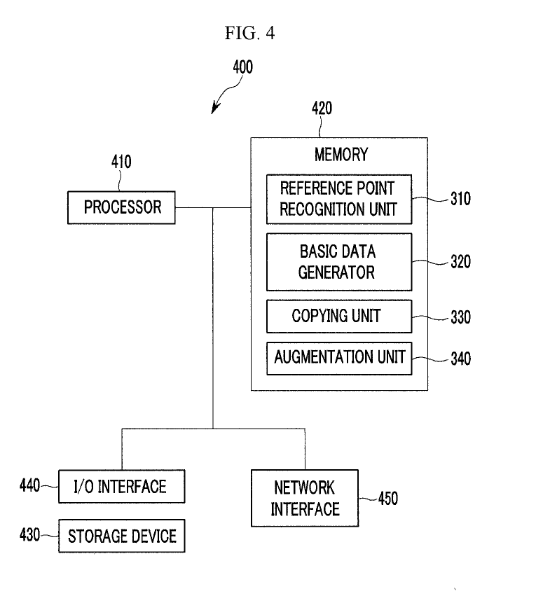

In what follows, an apparatus and method for operating multiple objects in combination with a computer system according to an exemplary embodiment will be described in detail with reference to FIG. 4.

FIG. 4 is a schematic view of an apparatus for operating multiple objects according to another exemplary embodiment of the present invention. This figure depicts a system that can be used to perform at least some of the functions of the reference point recognition unit 310, basic data generator 320, copying unit 330, and augmentation unit 340 explained with reference to FIGS. 1 to 3.

Referring to FIG. 4, the multiple object operating apparatus 400 includes a processor 410, a memory 420, a storage device 430, an input/output (I/O) interface 440, and a network interface 450.

The processor 410 may be implemented as a central processing unit (CPU), a chipset, a microprocessor, etc., and the memory 420 may be implemented as mediums such as a dynamic random access memory (DRAM), a rambus DRAM, (RDRAM), a synchronous DRAM (SDRAM), and a static RAM (SRAM). The storage device 430 may be implemented as optical disks, such as a hard disk, CD-ROM (compact disk read only memory), CD-RW (CD rewritable), DVD-ROM (digital video disk ROM), DVD-RAM, DVD-RW disk, and a blu-ray disk, a flash memory, and various types of permanent or volatile storage devices, such as RAM. The I/O interface 440 allows the processor 410 and/or the memory 420 to access the storage device 320, and the network interface 450 allows the processor 410 and/or the memory 420 to access a network.

In this case, the processor 410 can load a program command on the memory 420 to implement at least some of the functions of the reference point recognition unit 310, basic data generator 320, copying unit 330, and augmentation unit 340, and control such that the above-described operation is carried out with reference to FIGS. 1 to 3. Such a program command may be stored in the storage device 430, or in other systems connected to the network.

The processor 410, memory 420, storage device 430, I/O interface 440, and network interface 450 may be implemented in one computer, or in a plurality of computers in a distributed manner.

The above-described embodiments can be realized through a program for realizing functions corresponding to the configuration of the embodiments or a recording medium for recording the program in addition to through the above-described apparatus and/or method, which is easily realized by a person skilled in the art.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A method for operating multiple objects, the method comprising:
recognizing a reference point in an input image;
converting the reference point into basic data by pre-processing the reference point by binarization;
copying the basic data to at least one position of a screen where the image is to be output; and
augmenting an object on the screen by using a copy of the basic data as the reference point.

2. The method of claim 1, wherein the converting comprises:
extracting the contour of the reference point; and
pre-processing the contour by binarization.

3. The method of claim 2, wherein the extracting comprises:
extracting initial contours running parallel to and enclosing a contour of the reference point by using the Hough Transform Algorithm; and
coloring the space between two of the initial contours.

4. The method of claim 2, wherein the coloring comprises coloring two initial contours facing each other.

5. The method of claim 1, wherein the copying comprises setting up a protection area corresponding to each basic data so as to prevent overlap of the basic data when the basic data is copied to at least one position of the screen.

6. The method of claim 5, wherein, in the setting up, the protection area is set up by the Bresenham Algorithm.

7. The method of claim 1, wherein the copying comprises removing image noise from the basic data before copying the basic data to the screen.

8. The method of claim 7, wherein the removing comprises removing the image noise by applying the Mean Shift Algorithm to the basic data.

9. The method of claim 1, wherein the copying comprises, if a copy of the basic data is beyond the coverage of a screen, controlling at least one of the number of reference points and the size of the reference points.

10. An apparatus for operating multiple objects in an augmented reality system, the apparatus comprising:
a reference point recognition unit for recognizing a reference point in an input image;
a basic data generator for converting the reference point into basic data by pre-processing the reference point by binarization;
a copying unit for copying the basic data to at least one position of a screen where the image is to be output; and
an augmentation unit for augmenting an object on the screen by using the basic data as the reference point.

11. The apparatus of claim 10, wherein the copying unit sets up a protection area corresponding to each basic data so as to prevent overlap of the basic data when the basic data is copied.

12. The apparatus of claim 10, wherein the copying unit copies the basic data to the screen after removing image noise from the basic data.

13. The apparatus of claim 10, wherein the basic data generator converts the reference point into copyable basic data by extracting the contour of the reference point and binarizing the same
